(19) United States
(12) Patent Application Publication
(10) Pub. No.: US 2005/0236174 A1
(43) Pub. Date: Oct. 27, 2005

(54) Electrical touch/proximity switch cover plate

(76) Inventors: Michael James Morgan, Oceanside, CA (US); Thomas Micheal Rauscher, Oceanside, CA (US)

Correspondence Address: Rauscher Industries, 2257 Via Blanca, Oceanside, CA, 92054, US

(21) Appl. No.: 11/089,561

(22) Filed: Sep. 4, 2003

(51) Int. Cl. H02G 3/14

(52) U.S. Cl. 174/66

(57) ABSTRACT

An insert or cover plate for a electronic/electrical/touch/proximity/electromechanical switch comprising a plate having an image viewing area and apertures for mounting said plate to a switch, a sense electrode positioned behind said image viewing area and an image lens positioned behind said sense electrode for detecting the presence of objects for the electronic/electrical/touch/proximity switch.

### TECHNICAL FIELD

Field of endeavor is switch insert or cover plates for lighting, electrical, electronics and appliance controls with or without applicable symbols.

### BACKGROUND OF THE INVENTION

Patents on cover plates along with their reference numbers
1. U.S. Pat. No. 5,833,350
2. U.S. Pat. No. 4,009,797
3. U.S. Pat. No. 4,707,564

### SUMMARY OF THE INVENTION

An insert or cover plate for a electronic/electrical/touch/proximity/electromechanical switch comprising a plate having an image viewing area and apertures for mounting said plate to a switch, a sense electrode positioned behind said image viewing area and an image lens positioned behind said sense electrode for detecting the presence of objects for the electronic/electrical/touch/proximity switch. The insert or cover plate may further comprise a light diffuser positioned behind said sense electrode. The image lens may further comprise a solid color, a picture, an alphanumeric character, a logo, or a symbol and the image viewing area, image lens and light diffuser may be provided in a shape selected from the group consisting of a circle, an oval, an octagon, a heptagon, a hexagon, a pentagon, a square, a rectangle, a parallelogram, a rhomboid, a triangle, or a combination of these shapes.

### DESCRIPTION OF THE FIGURES

FIG. 1: Is a diagrammatic representation of two embodiments of the present invention showing (A) the cover plate with diffuser and (B) the cover plate without the diffuser.

FIG. 2: is a diagrammatic representation of one configuration of the front side of the cover plate.

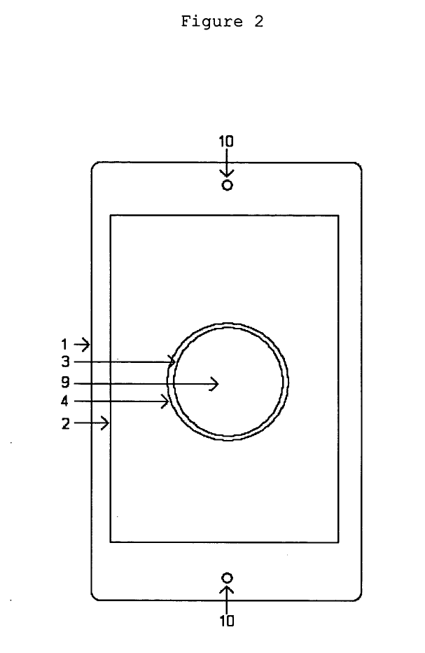

FIG. 3: is a diagrammatic representation of three configurations of the front side of the cover plate.

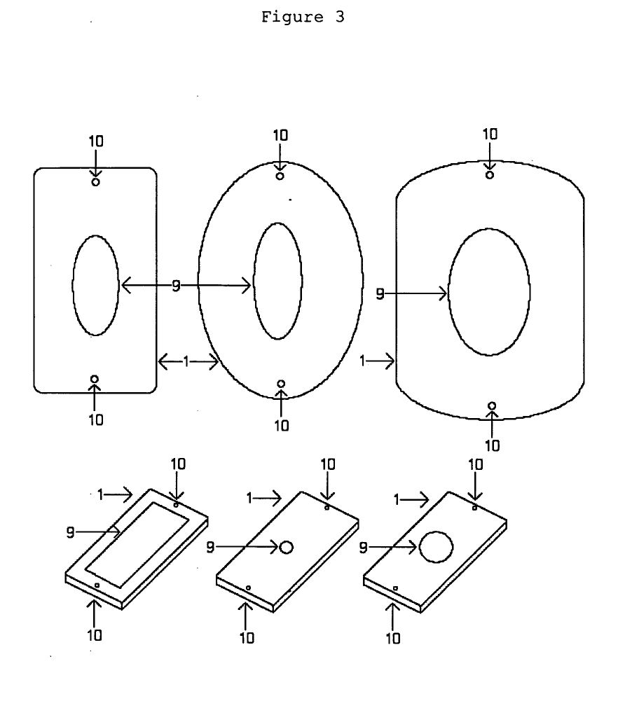

FIG. 4: is a photograph of the front side of the rectangular configuration of the cover plate.

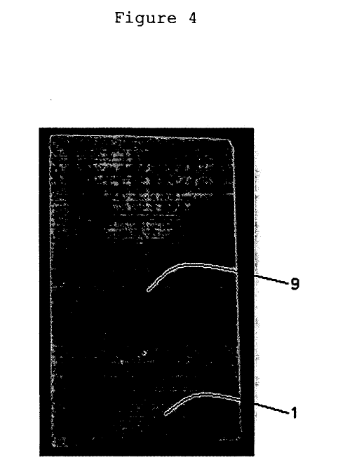

FIG. 5: is a photograph of the backside of the rectangular configuration of the cover plate with the sense electrode.

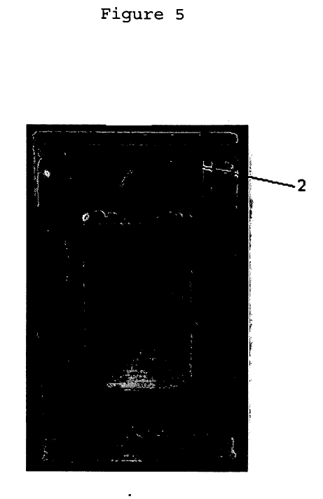

FIG. 6: is a photograph of the backside of the rectangular configuration of the cover plate with the light diffuser.

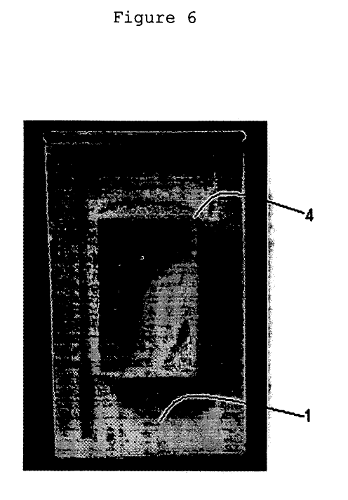

### DETAILED DESCRIPTION

The present invention provides a lighting and electronic appliance control switch insert or cover plate that acts as a sense electrode for an electronic/electrical/touch/proximity switch that includes an optional plastic, but not limited to, lens with the optional, but not limited to, ability to print, silk screen or use of a decal for the creation of an image.

An electronic/electrical/touch/proximity/electromechanical switch insert or cover plate with an imbedded sense electrode, image lens with or without light diffuser function to be used in conjunction with an electronic/electrical/touch/proximity/electromechanical with an optional light source

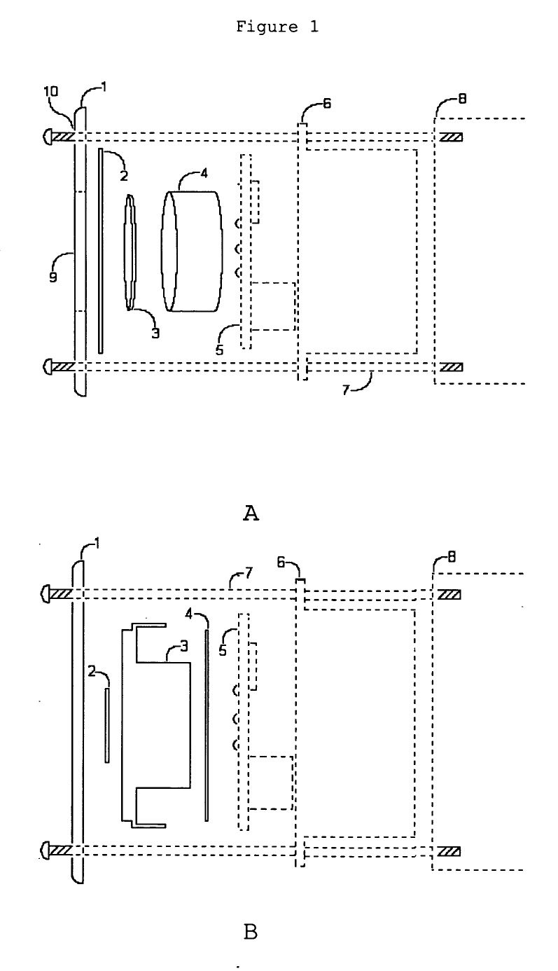

Insert or cover plate for electronic/electrical/touch/proximity/electromechanical switch includes the ability to backlight said image or to provide, but not limited to, a find or night light function. FIG. 1A shows a cover plate (1) incorporates an image viewing area, (9) to allow the image lens (3) to be inserted. Cover plate (1) includes two holes (10) for mounting with mounting screws (7) to the installed wall mounted utility box (8). The insert or cover plate (1) is molded in a way as to allow an image lens (3) to be installed. A light diffuser (4) is molded into or attached to cover plate in a way as to allow backlight to be received, in any manner, from, but not limited to, control/lighting PCB (5).

FIG. 1B, is and insert or cover plate molded in a manner as to eliminate diffuser to provide undiffused light from, but not limited to, control/lighting PCB (5). A sense electrode (2) is used for the detection or presence of an object and is affixed or imbedded to or separated from the insert or cover plate (1). The sense electrode (2) connects to the control/lighting PCB (5) via, but not limited to, a mechanical device, wire, clip, spring or electronic, capacitance or induction method. The sense electrode (2) size is determined, but not limited to, by the object it is to sense and is made up of any conductive material.

In FIG. 1 the control/lighting PCB (5), enclosure (6), installed wall mount utility box (8) are for illustration purposes only.

1. An insert or cover plate for a electronic/electrical/touch/proximity/electromechanical switch comprising: a plate having an image viewing area and apertures for mounting said plate to a switch; a sense electrode positioned behind said image viewing area; and an image lens positioned behind said sense electrode for detecting the presence of objects for the electronic/electrical/touch/proximity switch.

2. An insert or cover plate according to claim 1 further comprising a light diffuser positioned behind said sense electrode.

3. A insert or cover plate according to claim 1 wherein said image lens comprises a solid color, a picture, an alphanumeric character, a logo, or a symbol.

4. An insert or cover plate according to claim 1 wherein said image viewing area, image lens and light diffuser may be in a shape selected from the group consisting of a circle, an oval, an octagon, a heptagon, a hexagon, a pentagon, a square, a rectangle, a parallelogram, a rhomboid, a triangle, or a combination of these shapes.
